(19) United States
(12) Patent Application Publication
(10) Pub. No.: US 2015/0064492 A1
(43) Pub. Date: Mar. 5, 2015

(54) PATTERNED FILMS, LAYERED COMPOSITES FORMED THEREWITH, AND METHODS OF PREPARATION THEREOF

(71) Applicant: North Carolina State University, Raleigh, NC (US)

(72) Inventors: Goran Rasic, Raleigh, NC (US); Justin Schwartz, Cary, NC (US)

(73) Assignee: North Carolina State University

(21) Appl. No.: 14/471,295

(22) Filed: Aug. 28, 2014

Related U.S. Application Data
(60) Provisional application No. 61/871,584, filed on Aug. 29, 2013.

(51) Int. Cl. B05D 3/12; B32B 38/06; B32B 37/24; B32B 38/00; B05D 1/00; B05D 3/02

(52) U.S. Cl. CPC B05D 3/12; B05D 1/005; B05D 3/0254; B32B 37/24; B32B 38/0036; B32B 38/06; B32B 2037/243; B32B 2307/202; B32B 2307/208
USPC 428/600; 427/277; 427/130; 427/58; 156/182; 428/172; 428/173

(57) ABSTRACT

The present disclosure provides materials exhibiting improved properties arising from a surface treatment thereof. In particular, thin films can be provided with a patterned surface, the patterned thin films exhibiting improved properties such as in relation to coercivity, mechanical coupling, and magnetic coupling. The disclosure further provides layered composites comprising one or more patterned thin films. The disclosure also provides methods of forming patterned thin films.

### CROSS-REFERENCE TO RELATED APPLICATIONS

The present application claims priority to U.S. Provisional Patent Application No. 61/871,584, filed Aug. 29, 2013, the disclosure of which is incorporated herein by reference in its entirety.

### FIELD OF THE DISCLOSURE

The present disclosure relates to methods for patterning a surface of a layer, such as a thin film, so as to impart one or more improved properties to the layer, particularly in relation to coupling of the patterned layer to a further layer, which may also be patterned. The present disclosure further relates to patterned layers formed by the methods and layered composites comprising one or more of the patterned layers.

### BACKGROUND

Thin films can be utilized in forming a variety of materials and devices, and the usefulness of such thin films can be predicated upon various properties exhibited by the thin films. This can be seen, for example, in the formation of layered composites, such as magnetoelectric materials. Layered composites can be limited by the types of layers that may be combined and/or the nature of interfacial transfers between layers. There thus is a need in the art for methods and materials whereby thin films with improved properties may be provided, particularly for use in forming layered composites.

### SUMMARY OF THE DISCLOSURE

The present disclosure relates to thin films and methods of manufacture of thin films that improves one or more properties of the thin films through surface patterning. The improvements particularly can relate to interfacial properties of the thin films and thus can likewise provide for improved layered composites incorporating the patterned thin films. The thin films in specific embodiments can comprise magnetic materials. In some embodiments, the thin films may comprise electrically conductive materials or thermally conductive materials. Optically conductive materials also may be used in some embodiments.

In some embodiments, the present disclosure can provide a method for altering a property of a thin film. Such method can comprise patterning a surface of the thin film. In particular, the patterned thin film can improve interaction of the thin film with a further thin film. Various methods for patterning the thin film are encompassed by the present disclosure, particularly methods suitable for patterning of a metal or metal alloy surface. For example, patterning may be via an additive technique or a reductive technique. In an additive technique, a material may be deposited on the surface of the thin film to form the pattern. The patterning material may be identical in composition to the thin film or may be of a different composition. In a reductive technique, a portion of the surface of the thin film may be removed to form a series of grooves defining the pattern. Non-limiting examples of patterning techniques that are encompassed by the present disclosure include nanoimprinting, photolithography, electron beam, ion beam, x-ray, self-assembly, lift-off, and similar patterning methods.

In one exemplary method, patterning of a thin film can comprise the following steps: providing the thin film in a non-crystalline form; patterning the surface of the non-crystalline thin film; and crystallizing the thin film with the patterned surface. In some embodiments, the providing can comprise chemical solution deposition of the thin film. In further embodiments, the patterning can comprise nanoimprint lithography (NIL). More particularly, the NIL can comprise imprinting with a stamp, such as a polydimethylsiloxane (PDMS) stamp. For example, the method can comprise applying the stamp to the non-crystalline thin film, heating the non-crystalline thin film with the applied stamp, removing the stamp, and crystallizing the thin film with the patterned surface. In some embodiments, crystallizing may comprise heating the thin film with the patterned surface to a temperature of about 500° C. or greater. In other embodiments, the thin film can be in a crystalline form when patterned.

The thin film can comprise a metal or metal alloy or an oxide thereof. In particular, the thin film may comprise one or more of nickel, cobalt, and iron. In some embodiments, the thin film may include further elements or compounds. For example, oxides of metals and metal alloys may be useful. In other embodiments, the thin film may consist essentially of a metal or metal alloy or an oxide thereof. In further embodiments, the thin film may consist of a metal or metal alloy or oxide thereof.

Patterning of a surface of a thin film according to the present disclosure can improve or otherwise alter a variety of properties of the thin film relative to a non-patterned thin film of identical construction. For example, in some embodiments, the thin film with the patterned surface can exhibit a coercivity value that is less than the coercivity of a thin film of identical construction that is not patterned. In other embodiments, the thin film with the patterned surface can exhibit mechanical coupling with a further thin film that is improved relative to the mechanical coupling of the further thin film with a thin film of identical construction that is not patterned. In further embodiments, the thin film with the patterned surface can exhibit magnetic coupling with a further thin film that is improved relative to the magnetic coupling of the further thin film with a thin film of identical construction that is not patterned.

Further to the above, the present disclosure further can provide a method for forming a layered composite material. In some embodiments, the method can comprise: providing a first thin film with a patterned, interfacial surface; providing a second thin film with an interfacial surface; and attaching the second thin film to the first thin film at the interfacial surfaces. In some embodiments, the interfacing surface of the second thin film also can be patterned. Patterning of both interfacial surfaces can be adapted to provide an interference fit between the two surfaces that may be likened to a tongue and groove fit. More particularly, the patterned surface of the thin film can comprise one or more protrusions or indentations that correspond to one or more indentations or protrusions of the patterned surface of the second thin film. In some embodiments, the thin film can be a magnetostrictive material. In such embodiments, it may be useful for the second thin film to be a piezoelectric material.

In further embodiments, a method of forming a layered composite material can comprise: providing a first thin film with a patterned surface; and depositing a material on the patterned surface to form a second thin film integrally connected with the patterned surface of the first thin film. Preferably, the material is deposited such that the second thin film fills the indentations and overlies the protrusions forming the pattern of the first thin film.

Further to the above, the present disclosure also can provide a variety of compositions, including thin films and layered composites formed using the thin films. In some embodiments, the present disclosure provides a thin film comprising one or more of nickel, cobalt, and iron, the thin film having a patterned surface. In particular, the thin film can have an overall thickness of about 2 mm or less. Likewise, the patterned surface can be defined by a series of grooves and protrusion, the grooves having an average depth of about 5 nm to about 1 mm.

In other embodiments, the present disclosure can provide a magnetostrictive material comprising a metal or metal alloy thin film, the thin film having a patterned surface. In particular, the thin film can comprise one or more of nickel, cobalt, and iron. In still other embodiments, the present disclosure can provide a low coercivity magnetic material comprising a thin film having a patterned surface and exhibiting a coercivity of about 100 Oe or less.

In some embodiments, the present disclosure can provide a magnetoelectric layered composite. Such composite can comprise: a magnetostrictive thin film having a patterned interfacial surface; and a piezoelectric thin film having an interfacial surface. In particular, the magnetostrictive thin film and the piezoelectric thin film can be attached at the interfacial surfaces. In further embodiments, a layered composite according to the disclosure can comprise: a first thin film having a patterned surface defined by a series of grooves and protrusion, the grooves having an average depth of about 5 nm to about 1 mm, and the patterned thin film having an overall thickness of 2 mm or less; and a second thin film that is integral with the patterned surface of the first thin film such that at least a portion of the material forming the second thin film fills at least a portion of the grooves of the first thin film. Particularly, the first thin film comprises one or more of nickel, cobalt, and iron. As further described herein, such composites particularly benefit from the patterned nature of the surface of the magnetostrictive thin film in that the patterning can improve the properties of the composite and can allow for formation of composites utilizing materials that have heretofore not been believed to be suitable for formation of such composites.

In further exemplary embodiments, the present disclosure can encompass one or more of the following statements. The disclosure can relate to a method for altering a thin film, the method comprising:

providing the thin film in a non-crystalline form with a substantially flat and non-patterned surface; patterning the surface of the non-crystalline thin film; and crystallizing the thin film with the patterned surface; wherein one or more of the following conditions is satisfied: the crystallized thin film with the patterned surface exhibits a coercivity value that is less than the coercivity of the starting non-crystalline, non-patterned thin film; the crystallized thin film with the patterned surface exhibits mechanical coupling with a further thin film that is improved relative to the mechanical coupling of the further thin film with starting non-crystalline, non-patterned thin film; and/or the crystallized thin film with the patterned surface exhibits magnetic coupling with a further thin film that is improved relative to the magnetic coupling of the further thin film with starting non-crystalline, non-patterned thin film.

The step of providing the thin film can comprise forming the thin film via chemical solution deposition of the thin film.

The patterning can comprise a method selected from the group consisting of nanoimprinting techniques, photolithography techniques, electron beam techniques, ion beam techniques, x-ray techniques, self-assembly techniques, and lift-off techniques.

The patterning can comprise nanoimprint lithography (NIL), an optionally can comprise imprinting with a polydimethylsiloxane (PDMS) stamp.

The crystallizing can comprise heating the thin film with the patterned surface to a temperature of about 500° C. or greater.

The thin film can be one or more of magnetic, electrically conductive, optically conductive, and thermally conductive.

The thin film can comprise a metal or metal alloy or oxide thereof

The thin film can comprise one or more of nickel, cobalt, and iron.

The crystallized thin film with the patterned surface can comprise an interfacial surface, and the method further can comprise providing a second thin film with an interfacial surface and attaching the second thin film to the crystallized thin film at the interfacial surfaces.

The interfacial surface of the second thin film can be patterned.

The crystallized thin film with the patterned surface can comprise a series of grooves and protrusions, and the method further can comprise depositing a material on the patterned surface of the crystallized thin film such that the material fills the grooves and covers the protrusions of the patterned surface of the crystallized thin film to form a second thin film that is integral therewith.

A thin film according to the disclosure can comprise one or more of nickel, cobalt, and iron.

The thin film can have a patterned surface defined by a series of grooves and protrusions, the grooves having an average depth of about 5 nm to about 1 mm, and the thin film can have an overall thickness of about 2 mm or less.

The thin film can be magnetostrictive.

The thin film can exhibit a coercivity of about 100 Oe or less.

A layered composite according to the disclosure can comprise a first thin film attached to a second thin film, wherein the first thin film can have a patterned surface defined by a series of grooves and protrusions, the grooves having an average depth of about 5 nm to about 1 mm, and the first thin film can have an overall thickness of 2 mm or less.

The layered composite can be magnetoelectric.

The first thin film of the layered composite can be magnetostrictive and the second thin film can be piezoelectric.

The second thin film of the layered composite can be integral with the patterned surface of the first thin film such that at least a portion of the material forming the second thin film fills at least a portion of the grooves of the first thin film.

The first thin film of the layered composite can comprise one or more of nickel, cobalt, and iron.

### BRIEF DESCRIPTION OF THE FIGURES

Having thus described the disclosure in the foregoing general terms, reference will now be made to the accompanying drawings, which are not necessarily drawn to scale, and wherein:

FIG. 1 shows atomic force microscopy (AFM) images of a CD master (a), a PDMS stamp (b), and a patterned NiFe₂O₄ thin film grown on (0001) sapphire substrate;

FIG. 2 shows three transmission emission microscopy (TEM) cross-section images at different magnifications of patterned NiFe₂O₄ thin film grown on (0001) sapphire substrate;

FIG. 3 shows X-ray diffraction patterns of plain (a) and patterned (b) NiFe₂O₄ thin film grown on (0001) sapphire substrate; and

FIG. 4 shows superconducting quantum interference device (SQUID) VSM measurements of plain, patterned, and non-patterned NiFe₂O₄ thin film grown on (0001) sapphire substrate.

### DETAILED DESCRIPTION

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present disclosure provides materials and devices that benefit from a surprising improvement in various properties that is achieved through patterning of a surface of a thin film. The surprising improvements arising from surface patterning may particularly be seen in relation to formation of layered composites where patterning of an interfacial surface of at least one of the layers can improve coupling of the layers and thus improve overall properties of the composite or even allow for formation of a composite from layers that were previously believed to be incompatible. The present disclosure, however, is not so limited, and the surface patterning of the thin films can alter and improve properties of the patterned thin film by itself as well.

Thin films subject to the presently disclosed methods and materials may include films comprising metals and metal alloys. In exemplary embodiments, thin films according to the present disclosure may comprise one or more of nickel, cobalt, and iron. Compounds of such metals and metal alloys, including oxides thereof, particularly may be used. Further, the thin films may have a composition such that the thin film is one or more of magnetic, electrically conductive, optically conductive, and thermally conductive. As such, even further materials may be used in forming the thin films. Non-limiting examples include copper, silicon, gold, germanium, aluminum, zinc, platinum, titanium, and carbon. Oxides, carbides, and nitrides of any of the above materials also may be used according to the present disclosure.

The pattern features of the patterned thin film may be identical in composition to the material forming the thin film. As such, the pattern features may be monolithic with the thin film (e.g., wherein a pattern is formed by deposition of the thin film and removal of material to form grooves). In other embodiments, the pattern features may be separately formed on the surface of the thin film. In such embodiments, the pattern features may be formed of a material that is different in composition from the material used to form the thin film.

In some embodiments, the thin film may be characterized in that it has an overall thickness of about 2 mm or less, about 1 mm or less, about 0.1 mm or less, or about 0.01 mm or less, for example, about 10 nm to about 2 mm, about 20 nm to about 1 mm, or about 30 nm to about 0.5 mm. In other embodiments, the patterned thin films may be characterized in relation to the features of the pattern and/or the size of the features. For example, a pattern may be defined by a series of protrusions and/or grooves (or indentations) at the surface of the thin film. The features of the pattern may include lines, geometric patterns, grooves, divots, mounds, and similar physical elements. Feature size may relate to average depth of the grooves, average distance between protrusions, or both. Feature size may be about 5 nm to about 1 mm, about 10 nm to about 500 μm, or about 20 nm to about 300 μm. In further embodiments, the patterned thin films may be characterized in relation to the ratio of feature size to the overall thickness of the thin film. For example, pattern feature size may comprise up to about 90%, up to about 75%, or up to about 50% (e.g., about 1% to about 90%, about 5% to about 75%, or about 10% to about 50%) of the overall thickness of the thin film. The patterned thin films also may be characterized in relation to the periodicity of the pattern—i.e., the average distance between protrusions. In some embodiments, average pattern periodicity may be about 5 nm to about 500 μm, about 10 nm to about 100 μm, or about 20 nm to about 50 μm.

In certain embodiments, patterning as described herein may be useful to control one or more properties of a thin film using quantum effects. As one non-limiting example, surface patterning of a magnetic thin film can be effective to control the coercivity of the thin film. Particularly, a patterned thin film according to the present disclosure may exhibit a coercivity that is reduced relative to a thin film of identical construction that is not patterned. While not intending to be bound by theory, it is believed that patterning of the surface of a thin film as described herein can impart demagnetizing factors in the form of a reverse field that can be effective to lower the coercivity of the thin film. Reduced coercivity thin films according to the present disclosure particularly may be useful in applications where it is desirable to minimize magnetic losses due to hysteresis, improve linearity, and provide better switching.

In some embodiments, the present disclosure thus can provide low coercivity magnetic thin films. In particular, the magnetic thin films can exhibit a coercivity of about 100 Oe or less, about 75 Oe or less, or about 50 Oe or less.

In a further non-limiting example, surface patterning of a thin film can be effective to improve mechanical coupling of the thin film to a further thin film or other layer. As such, when the patterned thin film is combined with the further layer, the surface patterning may be characterized as interface patterning. As described above, the series of protrusions and indentations can improve the physical connection of the patterned surface to the further layer in relation to the same surface in the absence of the patterning. This can be particularly effective when patterning is also provided on the surface of the further layer. Likewise, mechanical coupling can be improved with patterning of one layer surface when the second layer is formed by deposition on the patterned surface layer. Thereby, the material forming the second layer can fill the grooves or indentations of the patterned surface and rise above the patterned surface as the thus formed second layer. The composite layers can then be characterized as being integrally formed. Patterning of the interface between the two layer surfaces can be effective to cause a tongue and groove type of interaction that can strengthen the physical connection between the two films. Moreover, the coupling in this manner can provide for improved direct transmission of the mechanical stress and strain between the two layers. Still further, the patterning on one or both surfaces can increase the surface area contact between the two layers, which likewise can improve the coupling effect, even in relation to a purely lattice matching connection.

In an example, the mechanical coupling improvement can be seen in relation to the formation of magnetoelectric materials. Previous efforts in the field of magnetoelectric composite materials have focused on improving the individual materials used in each layer and/or attempting to match compatible materials. This has been ineffective, however, in that many materials with very large ferroic ordering have been deemed incompatible. This has limited research to date to only a small number of combinations of materials that are deemed to be compatible. According to the present disclosure, however, patterning of the surface of one or both of the magnetostrictive film layer and the piezoelectric film layer can be effective to improve the coupling of the layers and allow for formation of magnetoelectric composite materials utilizing a wide variety of thin films of varying compositions. This is particularly illustrated in the Examples appended hereto. Similar effects can be seen in, for example, thermal transfer in a layered composite.

In a further example, the mechanical coupling improvement can be seen in relation to the formation of composite using layers of materials that previously have been believed to be incapable of use together. For instance, it is known that platinum layers will delaminate from silicon layers. Patterning of one or both of the layers may be effective to provide a stable lamination and allow for formation of composite materials that were previously not possible. Similarly, PbZrTiO₃ (PZT) and CoFe₂O₄ (CFO) are known to exhibit low coupling capacity, and patterning of one or both layers in a PZT/CFO composite can provide for improved properties beyond what is recognized in the art.

In still a further non-limiting example, surface patterning of a thin film can be effective to improve magnetic coupling of the thin film to a further thin film or other layer. It is known to combine antiferromagnetic (AFM) layers with ferromagnetic (FM) layers to achieve a preferential magnetic moment orientation and pin the layers together. Such materials, however, suffer from incomplete pinning since the AFM layer is not single domain, which causes domain randomness. Although not intending to be bound by theory, it is believed that patterning of the surface of one or both of the AFM and FM layers induces unitary orientation of the surface moments, which in turn can improve the pinning of the layers. This can be particularly useful in formation of improved read heads, spin valves, MRAM, and the like. Such magnetic coupling effect likewise can be achieved in other material types, such as ferrites, ferromagnets, antiferromagnets, paramagnets, and the like.

Patterning of a thin film according to the present disclosure can be achieved through a variety of methods. Such methods can comprise first depositing a layer of a material to form the thin film. A patterned mask or barrier layer (e.g., a photoresist) can then be applied to a surface of the thin film. Thereafter, a portion of the material forming the thin film may be removed according to the patterned mask, such as by etching, to form the pattern of grooves in the surface. Alternatively (or in combination), a further material may be deposited according to the patterned mask on the surface of the thin film to form the pattern of protrusion on the surface. After forming of the grooves and/or protrusions, the mask/barrier layer can be removed to leave behind the patterned surface. A non-limiting example of a patterning method that can be encompassed by the present disclosure includes lift-off wherein a film is deposited, a photoresist is applied, the photoresist is exposed (e.g., with light, such as in interference photolithography), the photoresist is developed (e.g., by removing sections to reveal the desired pattern), further film material is deposited over the photoresist, and the remaining photoresist is removed to leave behind the patterned surface. Further non-limiting examples of patterning methods that can be encompassed by the present disclosure includes etching techniques wherein a film is deposited and an electron beam, ion beam, atomic force microscopy (AFM), or the like is used to remove portions of the film and form the pattern. Similarly, a mask as described above can be used with etching chemicals, ion etching, plasma etching, and the like. Still further examples of patterning methods encompassed by the present disclosure include self-assembly and X-ray techniques.

In a specific, non-limiting example, stamping of a pattern in a thin film surface during formation of the thin film can be used. Nanoimprint lithography (NIL) using a polydimethylsiloxane (PDMS) stamp is one patterning method that may be used according to the present disclosure. Such method can particularly be combined with thin film formation using chemical solution (sol-gel) deposition (e.g., on a c-plane (0001) sapphire substrate). This is specifically described in the Examples.

Standard lithography procedures that include pressing a patterned stamp onto a photoresist covering the film and then using reactive ion etching (RIE) to create features may be utilized in some embodiments. A modified approach to NIL patterning that utilizes direct imprinting of the stamp on the thin film before the crystallization step also may be used. Resulting imprints show good pattern transfer with features that are copied with high degree of precision. Moreover, a high degree of crystallographic texture is achieved without being affected by the process of nanoimprinting.

Methods of patterning a thin film according to the present disclosure are not limited to the specifically exemplified embodiments. Rather, any method suitable for patterning a thin film surface to achieve a thin film and/or a composite material exhibiting the properties otherwise described herein may be used. See, for example, Pease and Chou, Proceedings of the IEEE, Vol. 96, No. 2, 1996, the disclosure of which is incorporated herein by reference in its entirety.

### EXAMPLES

The present invention is more fully illustrated by the following examples, which are set forth to illustrate the present invention and are not to be construed as limiting.

A solution of nickel ferrite (NFO) was prepared by mixing together Iron(III) nitrate nonahydrate (Fe(NO₃)₃.9H2O) and nickel(II) acetate tetrahydrate (C₄H₆NiO₄.4H₂O) in 2-methoxyethanol (CH₃OCH₂CH₂OH) solvent (all from Sigma-Aldrich). The solution was then stirred at 80° C. for 40 minutes and allowed to cool.

For comparison and evaluation of the procedure two sample configurations, plain and patterned, were used. To make the “plain” samples, 0.2 molar NFO solution was spin coated at 5000 rpm for 30 seconds onto a c-plane sapphire substrate. The sample was then subjected to pyrolysis at 400° C. for 1 min to remove the solvent and additional furnace annealing at 750° C. for 10 minutes was used to fully crystallize the film.

For pattern master, a commercially available compact disc (CD) was selected due to its consistent periodic features over large scale which allow for easy evaluation of the pattern transfer quality. To access the features, the top aluminum layer of the CD was removed and the CD was cleaned using isopropyl alcohol.

PDMS stamp was prepared using Sylgard-184 Silicone Elastomer Kit (Dow Corning) by mixing together silicone base and a curing agent in a 10:1 weight ratio respectively. After mixing, the PDMS was poured over the CD master, degased to remove the bubbles, and allowed to cure at 80° C. for 24 hours similar to procedures described by K. Efimenko et al., Journal of Colloid and Interface Science, 254, 306 (2002). After curing, the PDMS stamp was removed from the master and cut into smaller pieces for patterning.

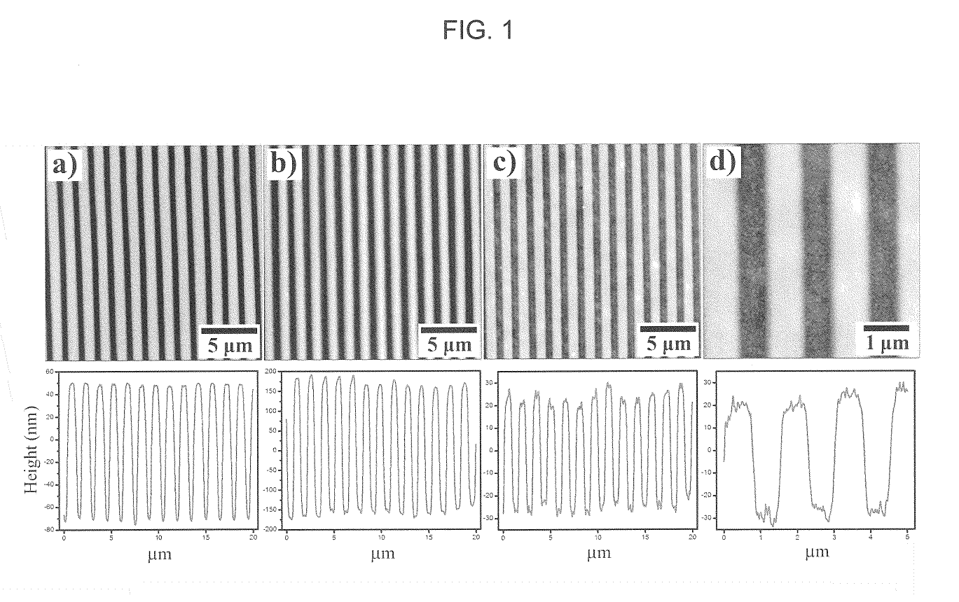

Patterning was done by pressing the PDMS stamp onto the spin coated NFO thin film with immediate pyrolysis at 400 ° C. for 1 min. After the pyrolysis, the stamp was removed and the patterned film was placed in the furnace to crystalize according to the aforementioned procedure. Samples made with the intermediate patterning step were designated “patterned.” Surface morphology of the patterned NFO thin films was evaluated using Cypher atomic force microscope (AFM) by Asylum Research in tapping mode (FIG. 1). AFM scan of the CD master showed consistent features with periodicity of ˜1.5 μm (FIG. 1a). The features were copied with high degree of precision to the PDMS stamp (FIG. 1b) and finally to the NFO thin films (FIGS. 1c and 1d). After demolding, it was observed that the PDMS stamp had closely mimicked the features from the CD master (FIG. 1b). There were no noticeable deviations from the master pattern, such as uneven, collapsed, or broken features nor were there any gas bubbles present in the PDMS stamp. Also, good conformity between the CD master and the PDMS stamp resulted in the good patterning of the entire PDMS stamp.

Surface morphology of the patterned NFO thin film in two different magnifications is shown in FIG. 1c and 1d. In lower magnification scan (FIG. 1c), it is seen that the pattern was transferred over large areas without cracking, bending, misalignment, feature collapse, air gaps and other defects, which are commonly encountered with NIL techniques.

In higher magnification scan (FIG. 1d) the high level of precision of the pattern and the individual grains making up the nanostructures can be seen. Surface morphologies and pattern transfer can be easily compared by looking at the roughness analysis bellow the FIG. 1a-d and reveal good consistency, The feature height reduction observed in NFO thin film (FIGS. 1c and 1d) is due to limited amount of material i.e. the thickness of NFO thin film after spin coating. Further analysis of FIG. 1d shows that the features in the patterned sample are made up of individual grains, indicating that there was no growth disruption of the NFO thin film by the PDMS stamp during the patterning process.

To confirm this, transmission electron images (TEM) of the sample cross-section were taken using FEI Titan 80-300 scanning transmission electron microscope (STEM). The microscope was used in TEM mode which allowed for better imaging. TEM sample preparation was done by focused ion beam (FIB) milling using FEI Quanta 3D FEG microscope. Before ion milling samples were carbon coated to prevent charging.

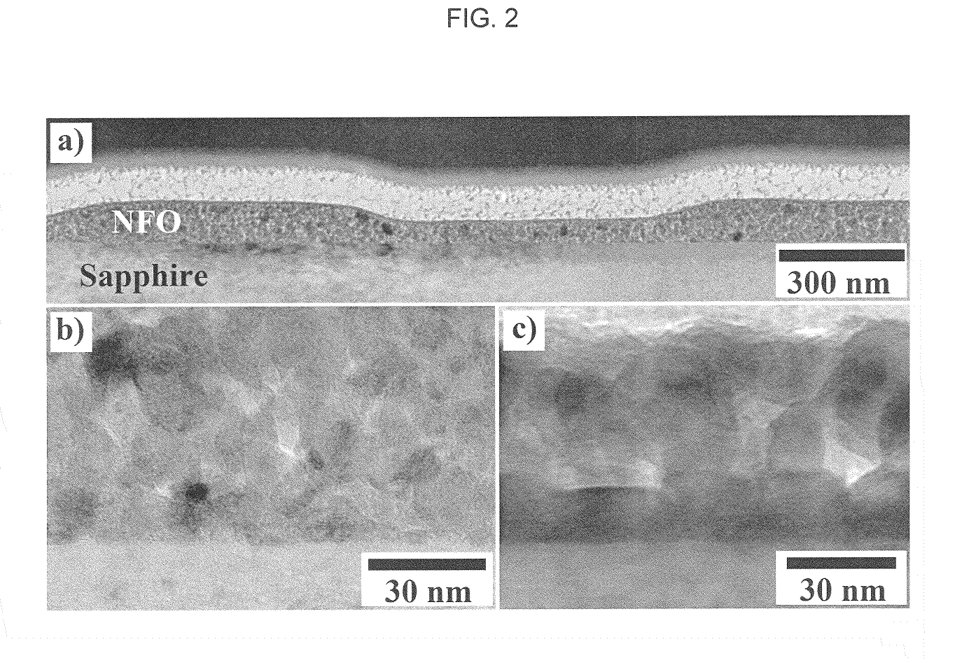

Cross-section TEM images of patterned NFO thin film (FIG. 2a,b) show that the film was 55 nm thick with 45 nm feature height and 1.5 μm periodicity. Surface features are sharp and precise with no apparent growth disruption by the PDMS mold. These results were consistent with results from the AFM measurements. No nucleation sites formed at the NFO/PDMS interface during the patterning process. This can be attributed to the insufficient thermal budget at the interface between the PDMS stamp and NFO thin film during patterning.

Plain sample image (FIG. 2c) shows that the features consisted of individual grains growing from the substrate indicating that the nucleation proceeds via island growth (Volmer-Weber) mechanism. Low lattice mismatch and favorable substrate orientation of the c-plane (0001) sapphire substrate caused the NFO thin film to crystalize preferentially in the easy axis <111> direction. If the thermal budget is at an optimum value, the nucleation from the substrate will fully crystalize the film before surface nucleation is started. Comparing different samples (FIG. 2b,c) less grain orientation is seen, and there was no evidence of substrate nucleation in the case of patterned sample (FIG. 2b) indicating the need for different processing conditions i.e. optimized thermal budget for the case of patterned thin films.

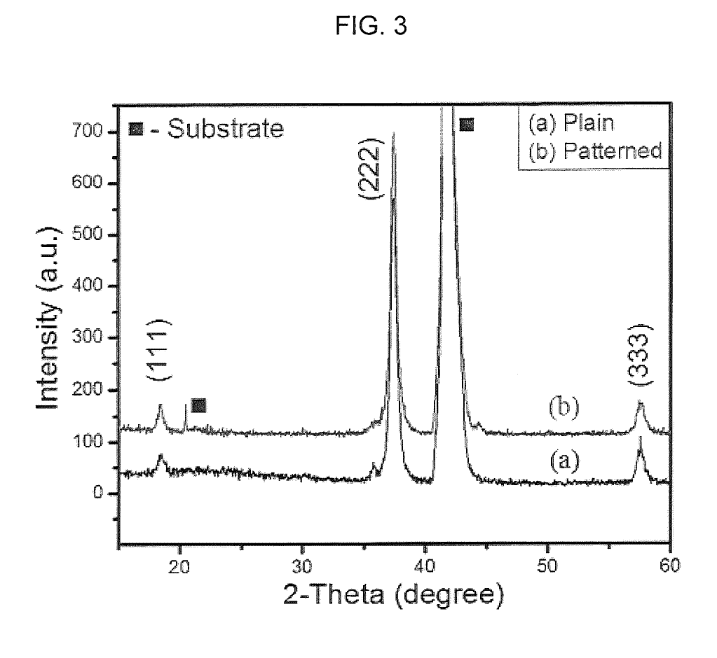

To check and compare the crystal structure and chemical composition of the films, both plain and patterned, X-Ray diffraction (XRD) was used. XRD θ-2θ scan was performed from 15° to 60° using Cu Ka radiation (X=1.5418 A) in a Smartlab Rigaku X-Ray diffractometer. XRD data for both configurations showed inverse spinel structure of the NFO film with no impurity phases present (FIG. 3). The peaks were calculated using Bragg's law and correlated with the reference PDF file. In both cases only peaks corresponding to {111} family of planes were seen, which confirmed the high degree of texture. This is in accordance with similar work on biaxially textured NFO thin films and consistent with other reports on epitaxial grown NFO thin films. Comparing the peaks present and their intensity (FIG. 3.) it was seen that the high degree of texture was fully retained and there was no noticeable grain misorientation or new phase formation. This confirmed that there was no significant grain growth disruption by the PDMS stamp during the patterning process nor were there new nucleation sites forming on the NFO/ PDMS interface.

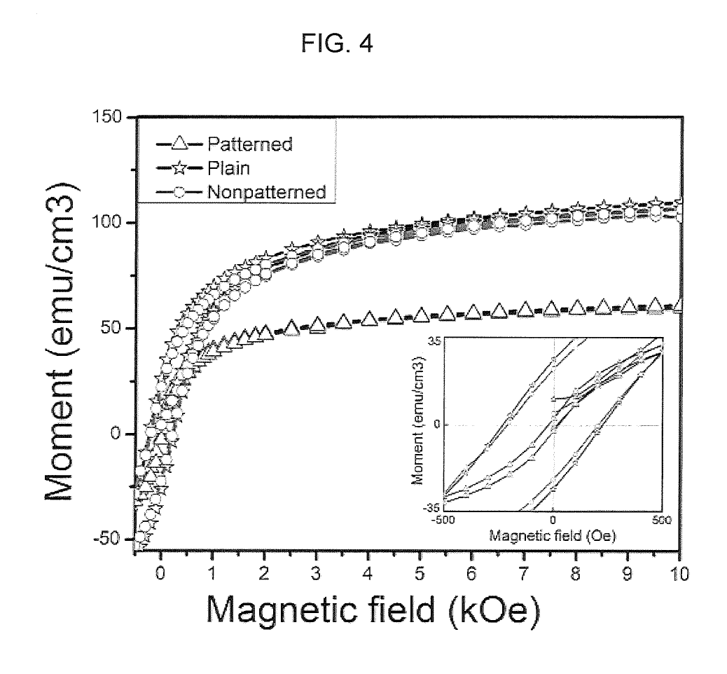

Magnetic properties were measured at room temperature using superconducting quantum interference device (SQUID). The samples were measured in-plane i.e. the field was parallel to the surface of the thin film with the magnetic field up to ±7 T. Due to the geometry of the SQUID used and very low thickness of our samples (FIG. 2), measurements with the samples perpendicular to the field were unsuccessful. Nevertheless most of the important data and general trends can still be seen. The substrate contribution to the measured magnetic data was removed and the data was normalized to the volume of the NFO thin film. Normalized magnetic hysteresis curves for the plain and patterned sample are shown in FIG. 4. For comparison, magnetic data for an area of patterned film that was not patterned (labeled “nonpatterned”) is also shown.

Saturation magnetization (Ms) values of plain and nonpatterned samples were very similar, 120 and 118 emu/cm³ respectively, and somewhat smaller than the results reported in similar work. This reduction can be attributed to using lower molarity solution, 0.2 M compared to 0.5 M used in literature. On the other hand, the saturation magnetization of the patterned sample was greatly reduced to 67.5 emu/cm³, which constitutes ˜44% reduction as compared to the plain samples. This can be attributed to processing conditions not being optimal for the case of patterned sample (as shown in FIG. 2) including features that were almost twice the size of the thin film and thus required larger thermal budget to fully crystallize.

Remnant magnetization values for all samples were very low, with remnant/saturation magnetization ratios (Mr/Ms) of 21.6%, 19.07% and 3.7%, for the plain, nonpatterned and patterned samples respectively. This was due to the magnetization not being along the easy axis direction.

Coercivity difference in the samples can be seen in the higher magnification image of the magnetic hysteresis curves show in inset of FIG. 4. Comparing the coercivity (Hc) of plain and nonpatterned samples it is seen that they again have similar values, 230 Oe and 210 Oe, respectively. The patterned sample, however, shows significantly smaller value of 25 Oe, which constitutes a reduction of ˜89% compared to the values of nonpatterned and plain samples. Usually it would be expected that an increase in coercivity would be seen with higher surface roughness due to change in domain wall movement. Instead, the opposite was observed. In this case the dominant factor is not the domain wall movement but the in-plane demagnetization factors that are amplified by the anisotropy of surface morphology. Demagnetizing field that arises caused coercivity to be greatly reduced.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A method for altering a thin film, the method comprising:
providing the thin film in a non-crystalline form with a substantially flat and non-patterned surface;
patterning the surface of the non-crystalline thin film; and
crystallizing the thin film with the patterned surface;
wherein one or more of the following conditions is satisfied:
the crystallized thin film with the patterned surface exhibits a coercivity value that is less than the coercivity of the starting non-crystalline, non-patterned thin film;
the crystallized thin film with the patterned surface exhibits mechanical coupling with a further thin film that is improved relative to the mechanical coupling of the further thin film with starting non-crystalline, non-patterned thin film;
the crystallized thin film with the patterned surface exhibits magnetic coupling with a further thin film that is improved relative to the magnetic coupling of the further thin film with starting non-crystalline, non-patterned thin film.

2. The method of claim 1, wherein the step of providing the thin film comprises forming the thin film via chemical solution deposition of the thin film.

3. The method of claim 1, wherein the patterning comprises a method selected from the group consisting of nanoimprinting techniques, photolithography techniques, electron beam techniques, ion beam techniques, x-ray techniques, self-assembly techniques, and lift-off techniques.

4. The method of claim 3, wherein the patterning comprises nanoimprint lithography (NIL), which optionally comprises imprinting with a polydimethylsiloxane (PDMS) stamp.

5. The method of claim 1, wherein crystallizing comprises heating the thin film with the patterned surface to a temperature of about 500° C. or greater.

6. The method of claim 1, wherein the thin film is one or more of magnetic, electrically conductive, optically conductive, and thermally conductive.

7. The method of claim 1, wherein the thin film comprises a metal or metal alloy or oxide thereof.

8. The method of claim 1, wherein the thin film comprises one or more of nickel, cobalt, and iron.

9. The method of claim 1, wherein the crystallized thin film with the patterned surface comprises an interfacial surface, and wherein the method further comprises providing a second thin film with an interfacial surface and attaching the second thin film to the crystallized thin film at the interfacial surfaces.

10. The method of claim 9, wherein the interfacial surface of the second thin film is patterned.

11. The method of claim 1, wherein the crystallized thin film with the patterned surface comprises a series of grooves and protrusions, and wherein the method further comprises depositing a material on the patterned surface of the crystallized thin film such that the material fills the grooves and covers the protrusions of the patterned surface of the crystallized thin film to form a second thin film that is integral therewith.

12. A thin film comprising one or more of nickel, cobalt, and iron, the thin film having a patterned surface defined by a series of grooves and protrusions, the grooves having an average depth of about 5 nm to about 1 mm, wherein the thin film has an overall thickness of about 2 mm or less.

13. The thin film of claim 12, wherein the thin film is magnetostrictive.

14. The thin film of claim 12, wherein the thin exhibits a coercivity of about 100 Oe or less.

15. A layered composite comprising:
a first thin film attached to a second thin film, wherein the first thin film has a patterned surface defined by a series of grooves and protrusions, the grooves having an average depth of about 5 nm to about 1 mm, and the first thin film has an overall thickness of 2 mm or less.

16. The layered composite of claim 15, wherein the layered composite is magnetoelectric.

17. The layered composite of claim 15, wherein the first thin film is magnetostrictive and the second thin film is piezoelectric.

18. The layered composite of claim 15, wherein the second thin film that is integral with the patterned surface of the first thin film such that at least a portion of the material forming the second thin film fills at least a portion of the grooves of the first thin film.

19. The layered composite of claim 15, wherein the first thin film comprises one or more of nickel, cobalt, and iron.
